(19) United States
(12) Patent Application Publication
(10) Pub. No.: US 2026/0295936 A1
(43) Pub. Date: Oct. 1, 2026

(54) APPARATUS AND METHOD FOR SURFACE TOOTHED-ROLL STRENGTHENING AND TOUGHENING OF ADDITIVELY MANUFACTURED CYLINDRICAL COMPONENT

(71) Applicant: Hefei University of Technology, Hefei (CN)

(72) Inventors: Siliang Yan, Hefei (CN); Xinli Xiang, Chongqing (CN); Miao Meng, Hefei (CN); Xiaogang Fang, Hefei (CN); Ping Li, Hefei (CN); Kemin Xue, Hefei (CN)

(21) Appl. No.: 19/385,191

(22) Filed: Nov. 11, 2025

(30) Foreign Application Priority Data
Mar. 28, 2025 (CN) 202510378589.7

(51) Int. Cl. B29C 64/188; B29C 64/30; B33Y 40/20; B33Y 80/00

(52) U.S. Cl. CPC B29C 64/188; B29C 64/30; B33Y 40/20; B33Y 80/00

(57) ABSTRACT

Provided are an apparatus and method for surface toothed-roll strengthening and toughening. The apparatus includes a lower die seat, an upper die seat, and guide columns. A rotating base is disposed inside the lower die seat, and a positioning assembly is disposed on the rotating base. An inner wall ultrasonic roller device is arranged on a bottom surface of the upper die seat. The inner wall ultrasonic roller device includes an inner wall radial slot seat, two inner wall roller seats, and two inner wall rollers. Two outer wall ultrasonic roller devices are symmetrically arranged on two sides of the inner wall ultrasonic roller device. Each outer wall ultrasonic roller device includes an outer wall radial slot seat, an outer wall roller seat, and an outer wall roller. Ultrasonic vibration devices are respectively disposed on the inner wall radial slot seat and the outer wall radial slot seat.

### CROSS-REFERENCE TO RELATED APPLICATION

This application claims priority to Chinese Patent Application No.202510378589.7, filed on March 28, 2025, which is herein incorporated by reference in its entirety.

### TECHNICAL FIELD

The disclosure relates to the technical field of metal roll forming, and more particularly to an apparatus and method for surface toothed-roll strengthening and toughening of an additively manufactured cylindrical component.

### BACKGROUND

Aerospace is a key direction for the development of a high-end equipment manufacturing industry. Aero-engine integral rings and aerospace rocket sections are core components in an aerospace field, with strict requirements on their structure and service performance. Structural characteristics of these components are typically large size, and complex geometry, and these components often need to withstand extreme mechanical loads, extreme temperature fluctuations, extreme vibration, and other environments. Service requirements include improved surface strength, fatigue resistance, and corrosion resistance. To meet these performance requirements, strengthening treatment usually needs performed on surfaces of the components, and organizational structure of the components needs optimization through suitable heat treatment or plastic processing techniques to ensure the reliability and stability of the components during long-term use. For large-scale integral precision components, if traditional long-process techniques are used, issues such as phase transformation and thermal/mechanical coupling can cause the evolution of residual stresses and loss of dimensional control, leading to degradation of shape and properties of the components. In contrast, an additive manufacturing (AM) technology has significant advantages, especially when it is used in precision components with complex shapes and large-sizes.

However, workpieces produced by laser additive manufacturing often cannot be used directly, primarily because surface layer structures and microstructures of these workpieces are difficult to fully meet strict service requirements. Firstly, the additive manufacturing process tends to form rough melt track textures and micro-defects on the surfaces of these workpieces, and the micro-defects can easily become initiation points for fatigue cracks under a cyclic stress, significantly reducing a fatigue life of these workpieces. Secondly, the microstructures of the workpieces produced by laser additive manufacturing are heterogeneous; surface grains of the microstructures may be fine but brittle, while an interior of the microstructures may contain coarse columnar grains or texture distribution, resulting in an undesirable performance gradient of grains. Components like the aerospace rocket sections typically require a strong and tough surface and a tough interior, which necessitates the formation of a reasonable performance gradient through special strengthening and toughening processes. For large, complex parts produced by the AM technology, traditional strengthening and toughening processes (such as heat treatment processes, cold working, or machining methods) face significant challenges in implementing their gradient strengthening and toughening, especially without compromising corresponding integrally formed structures. Heat treatment processes may cause deformation and stress redistribution in the complex parts produced by the AM technology, thereby damaging precision and microstructure of the complex parts produced by the AM technology. Traditional machining methods are also difficult to apply uniformly for plastic deformation on complex geometries, and excessive machining may lead to surface defects or changes in grain structure, thereby affecting overall material performances of the complex parts produced by the AM technology. However, gradient strengthening and toughening are crucial for high-load structures like rockets. By achieving gradient strengthening on inner and outer surfaces of cylindrical components, grain refinement can be performed on surface layers of the cylindrical components to enhance strength and fatigue resistance of the cylindrical components, while a coarser grain structure is retained in interiors of the cylindrical components to guarantee toughness. This structural optimization enables the cylindrical components to withstand temperature changes, mechanical loads, and dynamic impacts in extreme environments, markedly improving reliability and service life of the cylindrical components.

Current metal surface deformation strengthening technologies commonly include shot peening and surface roller pressing. A deformation hardening layer for the shot peening is relatively thin, generally 0.15 mm -1.5 mm. Although the shot peening can adapt to complex shape surfaces, it is mainly suitable for requirements focused on fatigue resistance. For applications requiring a thicker modification layer, the surface roller pressing is mostly used. The surface roller pressing involves a process where, under a certain pressure, a roller ball or roller shaft presses or extrudes a surface of a processed part, thereby causing plastic deformation and forming a strengthened layer. Currently, simple modifications or replacements of roller pressing tools allow limited microstructure control, but the roller pressing tools also share the limitations of the surface roller pressing, being only applicable to parts with simple shapes like flat plates and grooves, and cannot be applied to complex-shaped part surfaces, such as integrally formed cylindrical components by the AM technology. Based on the need for hardening of a thicker gradient microstructure, traditional strengthening and toughening roller pressing requires a larger roller pressure to obtain a thicker deformation layer. However, a phenomenon occurs, i.e., excessive roller pressure can cause uneven deformation on a metal surface, leading to surface defects. Different metal materials also have different hardness and different microstructure, especially for harder metals or additively manufactured components with insufficient surface hardness uniformity, the phenomenon becomes more pronounced.

### SUMMARY

To solve the above technical problems, the disclosure provides an apparatus and method for surface toothed-roll strengthening and toughening of an additively manufactured cylindrical component. The disclosure adopts an innovative process and an apparatus design solution, to perform gear-shaped rolling and flattening processes on inner and outer surfaces of a wall of the cylindrical component, to thus cause a surface layer material of the cylindrical component to undergo plastic deformation and accumulated plastic strain, thereby forming a structure with a gradient microstructure. In this process, the cylindrical component is fixed by a mold below the cylindrical component and rotates about a central axis of the cylindrical component. Core components of the apparatus include four helical gear rollers and four cylindrical rollers, distributed in pairs on the inner and outer surfaces at two opposite ends of the cylindrical component. Using the four helical gear rollers for continuous rolling allows for better continuity of force application on a wall of the cylindrical component. Moreover, the two pairs of helical gear rollers rotate in opposite directions. Through synchronous radial and axial feed motions of the two pairs of helical gear rollers, strengthening paths with a double-helix shape can be formed on the inner and outer surfaces of the wall of the cylindrical component, resulting in cross-shaped tooth marks different from traditional wave-like tooth marks. These tooth marks can provide more accumulated plastic strain in a single pass, while the process of the disclosure requires a lower feed depth during roller leveling, effectively mitigating disadvantages such as excessive wall thickness reduction and elongation. Through this design of the strengthening paths, it can not only fully cover an entire surface of the wall of the cylindrical component but also gradually strengthen a surface layer and an inner layer of the cylindrical component without destroying a macroscopic structure of the cylindrical component, achieving directional control of a gradient microstructure of the cylindrical component.

Different from traditional surface deformation strengthening, gradient strengthening requires a deeper feed amount. To avoid secondary processing defects while improving a strengthening and toughening effect, the disclosure further proposes a toothed-roll strengthening and toughening process combined with two-dimensional ultrasonic vibrations. The two-dimensional ultrasonic vibrations are set in a meshing direction of the helical gear roller and a direction perpendicular to the meshing direction, respectively. A two-dimensional vibration trajectory is an elliptical plane, with a major axis of the elliptical plane consistent with the meshing direction, and the elliptical plane tangent to the helical gear roller. By controlling amplitudes and phases in two excitation directions to achieve combination in the both directions, a shear angle can be increased, more effectively facilitating optimized deformation in a direction of helical tooth impression. Flattening rollers adopt simple two-dimensional vibration in radial and tangential directions, helping to promote stress transfer, alleviate excessive elongation and instability of the wall of the cylindrical component, and ensure dimensional stability after strengthening.

To solve the above technical problems, in a first aspect, the disclosure provides an apparatus for surface toothed-roll strengthening and toughening of an additively manufactured cylindrical component.

The apparatus for surface toothed-roll strengthening and toughening of an additively manufactured cylindrical component includes: a lower die seat, an upper die seat disposed above the lower die seat, and guide columns fixedly disposed between the lower die seat and the upper die seat. A rotating base is disposed inside the lower die seat, a positioning assembly is disposed on the rotating base, a first vertical positioning mechanism is disposed on a bottom surface of the upper die seat, and a bottom positioning end of the first vertical positioning mechanism is fixedly connected to an inner wall ultrasonic roller device; and the inner wall ultrasonic roller device includes: an inner wall radial slot seat, two inner wall roller seats symmetrically and slidably disposed in two ends of the inner wall radial slot seat, and two inner wall rollers rotatably disposed at two outer ends of the two inner wall roller seats, where axes of the two inner wall rollers are vertically arranged. Two outer wall ultrasonic roller devices are symmetrically arranged on two sides of the inner wall ultrasonic roller device; each of the two outer wall ultrasonic roller devices includes: an outer wall radial slot seat, an outer wall roller seat slidably disposed within the outer wall radial slot seat, and an outer wall roller, which is rotatably arranged at an end of the outer wall roller seat and arranged opposite to a corresponding one of the two inner wall rollers; each of the two outer wall ultrasonic roller devices is transmission-connected to a corresponding one of the guide columns through a second vertical positioning mechanism, and the two inner wall rollers and the two outer wall rollers of the two outer wall ultrasonic roller devices are helical cylindrical gears with opposite helical directions or cylindrical rollers. Each of the inner wall roller seat and the two outer wall roller seats of the two outer wall ultrasonic roller devices is provided with an ultrasonic vibration device thereon.

In an embodiment, the inner wall ultrasonic roller device further includes a horizontal bidirectional positioning mechanism, the horizontal bidirectional positioning mechanism is fixedly disposed on an outer wall of the inner wall radial slot seat, the two inner wall roller seats are fixedly connected to two positioning output ends of the horizontal bidirectional positioning mechanism, respectively, and the two inner wall roller seats are configured to move synchronously towards or away from each other.

In an embodiment, the horizontal bidirectional positioning mechanism includes: a first drive motor, fixedly disposed on the inner wall radial slot seat, a bidirectional screw, horizontally and rotatably disposed on the inner wall radial slot seat, and two first nut blocks, threadedly connected to two ends of the bidirectional screw, respectively; an end of each of the two first nut blocks penetrates the inner wall radial slot seat and is fixedly connected to a corresponding one of the two inner wall roller seats, respectively; and an output shaft end of the first drive motor is transmission-connected to a middle part of the bidirectional screw through a gear pair.

In an embodiment, two first radial guide grooves are respectively provided on inner surfaces of upper and lower walls of the inner wall radial slot seat, and upper and lower ends of each of the two inner wall roller seats are slidably embedded in the two first radial guide grooves, respectively.

In an embodiment, each of the two outer wall ultrasonic roller devices further includes a horizontal positioning mechanism; the horizontal positioning mechanism is fixedly disposed on an outer wall of the outer wall radial slot seat of the outer wall ultrasonic roller device; the horizontal positioning mechanism includes: a second drive motor, fixedly disposed on the outer wall radial slot seat of outer wall ultrasonic roller device, a screw, rotatably disposed on the outer wall radial slot seat, and a second nut block, threadedly connected to the screw; an end of the second nut block penetrates the outer wall radial slot seat of the outer wall ultrasonic roller device and is fixedly connected to the outer wall roller seat of the outer wall ultrasonic roller device; and an output shaft end of the second drive motor is transmission-connected to an end of the screw.

In an embodiment, two second radial guide grooves are respectively provided on inner surfaces of upper and lower walls of the outer wall radial slot seat, and upper and lower ends of each of the two outer wall roller seats are slidably embedded in the two second radial guide grooves.

In an embodiment, the ultrasonic vibration device disposed on the inner wall ultrasonic roller device includes two ultrasonic vibrators, which are respectively disposed on a first vertical side surface of the inner wall roller seat facing away from the inner wall roller and a second vertical side surface adjacent to the first vertical side surface; and the ultrasonic vibration device disposed on each of the two outer wall ultrasonic roller devices includes two ultrasonic vibrators, which are respectively disposed on a third vertical side surface of the outer wall roller seat of the outer wall ultrasonic roller device facing away from the outer wall roller and a fourth vertical side surface adjacent to the third vertical side surface.

In an embodiment, axes of the two inner wall rollers and axes of the two outer wall rollers are located in a same vertical plane, and a rotation axis of the rotating base is located within the same vertical plane.

In a second aspect, the disclosure further provides method for surface toothed-roll strengthening and toughening of an additively manufactured cylindrical component, applied to the apparatus for surface toothed-roll strengthening and toughening of the additively manufactured cylindrical component described above, and the method includes the following steps:

S1, fixing the cylindrical component on the rotating base;

S2: designing the two inner wall rollers and the two outer wall rollers as the helical cylindrical gears, and initially positioning the two inner wall rollers and the two outer wall rollers at lowest positions;

S3, setting a rotation speed of the cylindrical component, a radial feed parameter of each of the two inner wall rollers and the two outer wall rollers, an axial feed parameter of each of the two inner wall rollers and the two outer wall rollers and ultrasonic vibration parameters;

S4, starting each the ultrasonic vibration device, and synchronously feeding the two inner wall rollers and the two outer wall rollers radially towards a wall of the cylindrical component until the two inner wall rollers and the two outer wall rollers bite into the wall of the cylindrical component;

S5, driving, by the rotating base, the cylindrical component to rotate at a preset constant speed; once the cylindrical component rotates one revolution, synchronously feeding the two inner wall rollers and the two outer wall rollers upward by a single roller axial width until each of the two inner wall rollers and the two outer wall rollers completely rolls over an uppermost end of the cylindrical component, then pausing the apparatus;

S6, replacing the helical cylindrical gears with cylindrical rollers, each of the cylindrical rollers has a diameter the same as each of the helical cylindrical gears, positioning the cylindrical rollers to the lowest positions, and repeating the steps S4 to S5 to complete a roller leveling process of the wall of the cylindrical component;

S7, gradually reducing a radial feed distance of each of the cylindrical rollers biting into the wall of the cylindrical component by a preset reduction amount, and repeating the steps S3 to S6 for a preset number of times to complete a gradient structure strengthening and toughening of the wall of the cylindrical component; and

S8, removing the cylindrical component, and performing heat treatment optimization and surface repair on the cylindrical component.

In an embodiment, the radial feed distance of each of the cylindrical rollers is less than that of each of the helical cylindrical gears in a same pass.

Compared with the prior art, the beneficial effects of the disclosure are as follows.

The disclosure aims to achieve gradient microstructure strengthening and toughening for integrally additively manufactured cylindrical components. It proposes a process utilizing toothed-roll pressing and flattening for gradient microstructure strengthening and toughening of additively manufactured cylindrical components, as well as an integrated process apparatus designed according to the integral forming process characteristics of additively manufactured cylindrical components. Without changing the workpiece structure, it can efficiently, with high quality, and with high degree of freedom achieve gradient strengthening and toughening of the microstructure and properties of the entire inner and outer walls. It solves the problem of difficulty in achieving deep layer microstructure modification for already formed cylindrical components without changing their structure. The overall structure of the apparatus is innovative.

The roller device of the disclosure adopts two-dimensional ultrasonic vibration assistance. Through ultrasonic vibration, it reduces processing force, improves surface quality, enhances material deformability, reduces residual stress, and improves processing efficiency. It solves a series of problems such as surface defects, insufficient material fluidity, easy wear of rollers, and low efficiency brought by deep layer microstructure modification under large feed amounts. It effectively achieves effects such as reducing material yield strength, reducing flow stress, alleviating local stress concentration, optimizing the microstructure of the surface and near-surface layer, and promoting more uniform plastic deformation on the surface, forming a more uniform and refined grain structure, improving surface strength and fatigue resistance, while reducing the risk of defects such as cracks.

The disclosure uses helical gear rollers for roller pressing strengthening. During a helical feed process, it can locally and progressively bite in, making engagement more sufficient and roller rotation more stable. Moreover, for the helical tooth structure, before the engagement of a previous tooth ends, a next tooth has already started to bite in, making the engagement more sufficient, continuous, and progressive. Compared with traditional toothed-roll pressing, it achieves smoother roller feed and rotation, as well as more stable roller pressure, making the roller pressure more uniform and the rolling process more stable.

The disclosure uses symmetrical double helical gear rollers, which can achieve two pressing impressions in one pass. Their double helical cross trajectories and mutually perpendicular cross-shaped tooth marks make the rolling efficiency higher, more effectively accumulating plastic strain while reducing the depth of the tooth marks, thereby alleviating excessive thinning and elongation of the cylinder wall during flattening.

The disclosure adopts a multi-pass roller tooth pressing and flattening process, and a feed amount of the rollers towards the cylinder wall gradually decreases in each pass. This can alleviate surface defect problems such as crack initiation and stress concentration caused by large feed amounts, while making the gradient change of the microstructure more significant.

### BRIEF DESCRIPTION OF DRAWINGS

FIG. 1 illustrates a schematic perspective view of an apparatus for surface toothed-roll strengthening according to an embodiment of the disclosure.

FIG. 2 illustrates a schematic perspective view corresponding to an assembled state of a cylindrical component on the apparatus for surface toothed-roll strengthening and strengthening.

FIG. 3 illustrates a schematic perspective view of an inner wall ultrasonic roller device according to an embodiment of the disclosure.

FIG. 4 illustrates a schematic structural view of an assembled state of an ultrasonic vibration device on an inner wall roller seat according to an embodiment of the disclosure.

FIG. 5 illustrates a schematic perspective view of an outer wall ultrasonic roller device according to an embodiment of the disclosure.

FIG. 6 illustrates an enlarged schematic structural view of a portion A in FIG. 1.

FIG. 7 illustrates a schematic structural view of an assembled state of an ultrasonic vibration device on an outer wall roller seat according to an embodiment of the disclosure.

FIG. 8 illustrates an effective plastic strain diagram of the cylindrical component after one pass of a bottom circle roller tooth pressing obtained by simulation.

FIG. 9 illustrates an effective plastic strain diagram of the cylindrical component after one pass of multi-layer spiral roller tooth pressing obtained by simulation.

FIG. 10 illustrates a radial distribution and curve of a plastic strain in a wall of the cylindrical component during a roller tooth pressing stage of one pass obtained by simulation.

FIG. 11 illustrates a radial distribution and curve of an accumulated plastic strain in the wall of the cylindrical component during a roller flattening stage of one pass obtained by simulation.

FIG. 12 illustrates a schematic diagram of a thickness and height change of the wall of the cylindrical component during the roller flattening stage of one pass obtained by simulation.

### REFERENCE NUMERALS

1. Lower die seat; 2. Upper die seat; 3. Guide column; 4. Rotating base; 5. Positioning assembly; 501. Positioning inner core; 502. Positioning pressure ring; 503. Positioning wedge block; 6. First vertical positioning mechanism; 601. Bottom positioning end; 7. Inner wall ultrasonic roller device; 701. Inner wall radial slot seat; 7010. First radial guide groove; 702. Inner wall roller seat; 7021. Outer end; 7022. First vertical side surface; 7024. Second vertical side surface; 703. Inner wall roller; 704. Horizontal bidirectional positioning mechanism; 7041. First drive motor; 70410. Output shaft end; 7042. Bidirectional screw; 7043. First nut block; 7044. Gear pair; 8. Outer wall ultrasonic roller device; 801. Outer wall radial slot seat; 8010. Second radial guide groove; 802. Outer wall roller seat; 8022. Third vertical side surface; 8024. Fourth vertical side surface; 803. Outer wall roller; 804. Horizontal positioning mechanism; 8041. Second drive motor; 80410. Output shaft end; 8042. Screw; 8043. Second nut block; 9. Second vertical positioning mechanism; 901. Third drive motor; 902. Lifting gear; 903. Rack; 10. Ultrasonic vibration device; 100. Cylindrical component.

### DETAILED DESCRIPTION OF EMBODIMENTS

Embodiments of the disclosure are described in detail below with reference to the accompanying drawings, so that advantages and features of the disclosure can be more easily understood by those skilled in the art, thereby defining the scope of protection of the disclosure more clearly and definitively.

It should be noted that when a component is referred to as being “mounted on” another component, the component may be directly on another component or there may be an intervening component. When a component is considered to be “disposed on” another component, the component may be directly disposed on another component or there may be an intervening component. When a component is considered to be “fixed onto” another component, the component may be directly fixed to another component or there may be an intervening component.

Unless otherwise defined, all technical and scientific terms used herein have the same meanings as commonly understood by those skilled in the technical field of the disclosure. Terms used in the specification of the disclosure are for the purpose of describing specific embodiments only and are not intended to limit the disclosure. A term “and/or” used herein includes any and all combinations of one or more related listed items.

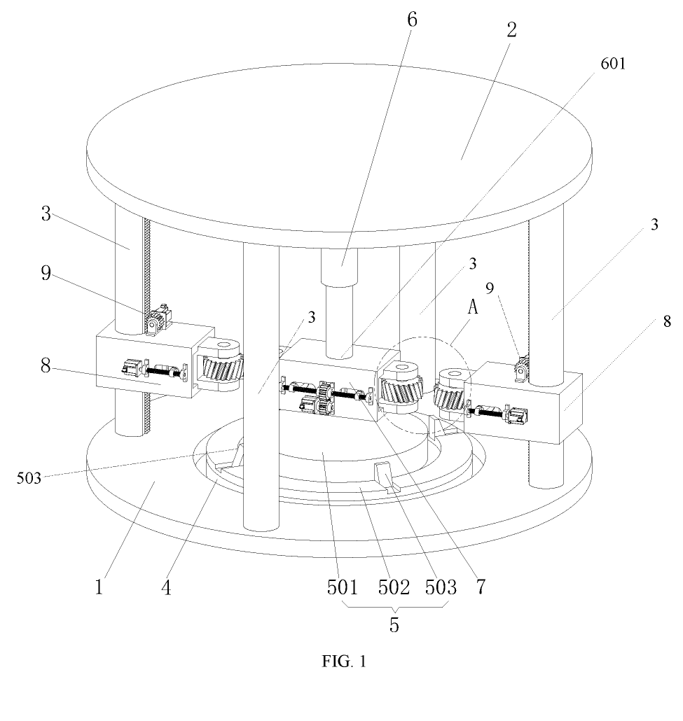

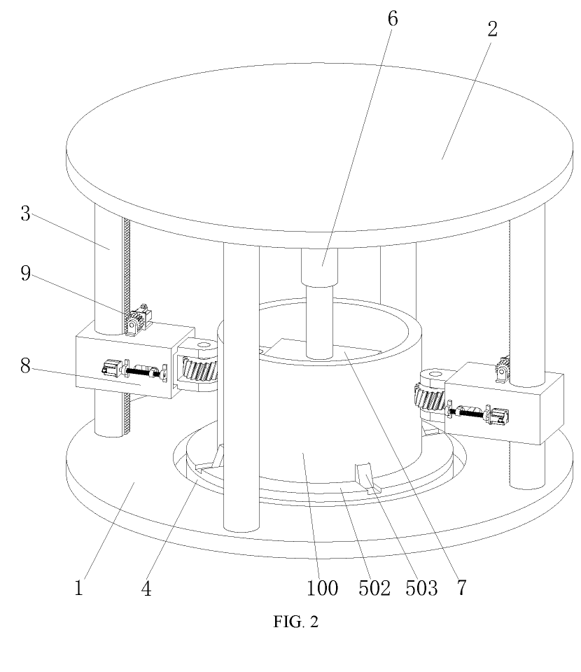

Referring to FIG. 1 through FIG. 7, an apparatus for surface toothed-roll strengthening and toughening of an additively manufactured cylindrical component is provided, which includes a lower die seat 1, an upper die seat 2 disposed above the lower die seat 1, and four guide columns 3 fixedly disposed between the lower die seat 1 and the upper die seat 2. The lower die seat 1 is a hollow disc, i.e., a ring-shaped disc. The upper die seat 2 is a solid disc of a diameter the same as that of the lower die seat. The four guide columns 3 are cylindrical bodies uniformly arranged at front, rear, left, and right positions on a top surface of the lower die seat 1, forming a stable support frame. Alternatively, a gantry frame can also be used to replace the four guide columns 3.

A rotating base 4 is disposed inside the lower die seat 1. The rotating base 4 is used to place a cylindrical component 100 to be strengthened thereon and provide a power for rotating the cylindrical component 100. A bottom of the rotating base 4 is driven by a rotational power output device (such as, an electric motor drive mechanism). In this embodiment, the rotating base 4 is a torsion platform of an existing torsion forming apparatus. A control system of the torsion forming apparatus can be directly used to set rotational process parameters of the rotating base 4, while control logic programs for other working components are added in the control system to realize a motion logic control of each functional component of the apparatus in the disclosure.

A positioning assembly 5 is disposed on the rotating base 4. The positioning assembly 5 includes a positioning inner core 501 fixedly disposed at a center of a top surface of the rotating base 5 and a positioning pressure ring 502 disposed outside the positioning inner core 501. The positioning inner core 501 is a disc structure, coaxially arranged with the rotating base 4, and an outer diameter of the positioning inner core 501 matches an inner wall diameter of a bottom end of the cylindrical component 100. After the cylindrical component 100 is placed on the rotating base 4, the bottom end of the cylindrical component 100 is sleeved outside the positioning inner core 501. Cooperation between an inner wall of the cylindrical component 100 and an outer cylindrical side surface of the positioning inner core 501 ensures that an axial position of the cylindrical component 100 and an axial perpendicularity (based on a rotation axis of the rotating base 4) of the cylindrical component 100 are within a preset error range, thereby avoiding problems such as large-area uneven stress distribution and instability caused by tilting of the cylindrical component 100. The positioning pressure ring 502 is an annular plate, coaxially arranged with the positioning inner core 501, and the positioning pressure ring 502 is fastened to a top surface of the rotating base 4 by bolts. Multiple positioning wedge blocks 503 (four positioning wedge blocks 503 in this embodiment) are uniformly distributed around a central axis of the positioning pressure ring 502 on a top surface of the positioning pressure ring 502. A bottom end of each positioning wedge block 503 is in sliding cooperation with a top end of the positioning pressure ring 502 through a dovetail groove structure disposed radially along the positioning pressure ring 502. An adjustment screw (not shown in the FIG. 1) is threadedly connected to an outer side surface of each positioning wedge block 503. The adjustment screw is rotatably disposed on an outer wall of the positioning pressure ring 502. By rotating the adjustment screw, a radial position of the positioning wedge block 503 on the positioning pressure ring 502 can be adjusted. Then, after the cylindrical component 100 and the positioning inner core 501 complete a positioning cooperation, by adjusting radial positions of the multiple positioning wedge blocks 503, the cylindrical component 100 can be clamped and fixed through cooperation between the multiple positioning wedge blocks 503 and the positioning inner core 501, and pressures of the multiple positioning wedge blocks 503 can be kept consistent (a surface deformation of the cylindrical component 100 after pressing on the cylindrical component 100 should be within 2 mm to 4 mm), preventing the cylindrical component 100 from sliding during a rotational processing due to uneven friction, which would affect a subsequent rolling strengthening process.

A first vertical positioning mechanism 6 is disposed on a bottom surface of the upper die seat 2. A bottom positioning end 601 of the first vertical positioning mechanism 6 is fixedly connected to an inner wall ultrasonic roller device 7. The inner wall ultrasonic roller device 7 is used for rolling strengthening of an inner wall surface of the cylindrical component 100. The first vertical positioning mechanism 6 is used for controlling a uniform feed of the inner wall ultrasonic roller device 7 in an axial direction of the cylindrical component 100, so that the inner wall ultrasonic roller device 7 can achieve full roller-pressure coverage of an inner wall in the axial direction of the cylindrical component 100 through axial spiral layer-by-layer superposition. For this purpose, the first vertical positioning mechanism 6 is a power mechanism capable of step-by-step feeding and positioning. In this embodiment, the first vertical positioning mechanism 6 may be an electric cylinder, which can not only meet the needs of uniform linear feeding in a straight-line direction but also achieve precise positioning. At the same time, when the first vertical positioning mechanism 6 is the electric cylinder, a feeding distance and speed can be easily set and adjusted by adjusting control parameters, thereby making it flexible and convenient to use. Moreover, the electric cylinder is a commercially available product, which can simplify the structural design of this equipment and reduce the production cost of the equipment.

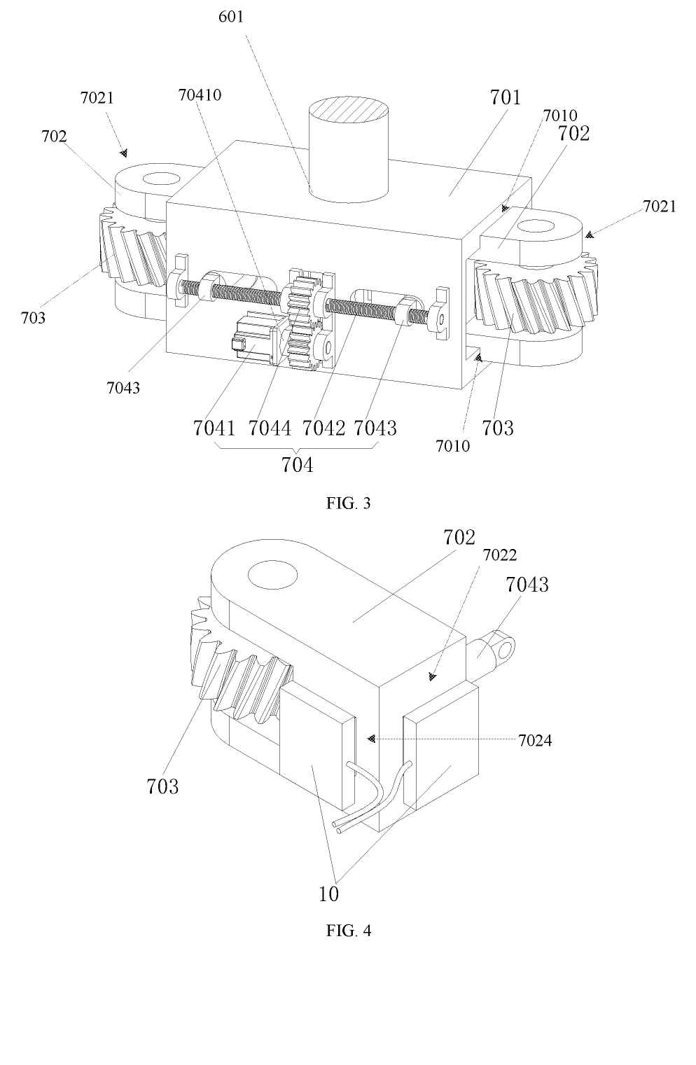

As illustrated in FIG. 3, the inner wall ultrasonic roller device 7 includes an inner wall radial slot seat 701, two inner wall roller seats 702 symmetrically and slidably disposed in two ends of the inner wall radial slot seat 701, two inner wall rollers 703 rotatably disposed at outer ends 7021 of the two inner wall roller seats 702 with axes of the two inner wall rollers 703 arranged vertically, and a horizontal bidirectional positioning mechanism 704 fixedly disposed on an outer wall of the inner wall radial slot seat 701. The two inner wall roller seats 702 are fixedly connected to two positioning output ends of the horizontal bidirectional positioning mechanism 704, respectively. Specifically, two first radial guide grooves 7010 are respectively provided on inner surfaces of upper and lower walls of the inner wall radial slot seat 701. Upper and lower ends of each inner wall roller seat 702 are slidably embedded in the two first radial guide grooves 7010, allowing the inner wall roller seat 702 to move horizontally within the inner wall radial slot seat 701, and achieving radial position adjustment of the corresponding one inner wall roller 703 on the inner wall roller seat 702 through extension or retraction. Since the two inner wall rollers 703 at two ends of the inner wall ultrasonic roller device 7 need to simultaneously perform the same rolling strengthening on inner wall surfaces at two ends of the cylindrical component 100, in this embodiment, a vertical center plane of the inner wall radial slot seat 701 is set to coincide with an axis of the rotating base 4. The two inner wall roller seats 702 are symmetrically arranged left and right within the inner wall radial slot seat 701, and are driven by the horizontal bidirectional positioning mechanism 704 to move synchronously towards or away from each other, keeping axes of the two inner wall rollers 703 symmetrically distributed on two sides of the axis of the rotating base 4.

In this embodiment, the horizontal bidirectional positioning mechanism 704 includes a first drive motor 7041 fixedly disposed on the inner wall radial slot seat 701, a bidirectional screw 7042, horizontally and rotatably disposed on the inner wall radial slot seat 701, and two first nut blocks 7043 threadedly connected to two ends of the bidirectional screw 7042, respectively. Two ends of the two first nut blocks 7043 penetrate the inner wall radial slot seat 701 and are fixedly connected to the two inner wall roller seats 702, respectively. An output shaft end 70410 of the first drive motor 7041 is transmission-connected to a middle part of the bidirectional screw 7042 through a gear pair 7044. Specifically, the first drive motor 7041 is a servo motor and is fixedly installed on the inner wall radial slot seat 701 through a motor mounting seat. The output shaft end 70410 of the first drive motor 7041 is fixedly connected to a drive gear. Threaded segments at two ends of the bidirectional screw 7042 have opposite spiral directions. The two ends of the bidirectional screw 7042 are rotatably disposed on a side of the inner wall radial slot seat 701 via bearing seats. A driven gear is fixedly sleeved on a middle section of the bidirectional screw 7042, and the driven gear meshes with the drive gear. By driving the bidirectional screw 7042 to rotate through the first drive motor 7041, the two first nut blocks 7043 and the two inner wall roller seats 702 fixedly connected thereto are driven to move synchronously towards or away from each other through the threaded transmission between the bidirectional screw 7042 and the two first nut blocks 7043, thereby realizing the radial feeding of the two inner wall rollers 703 on the inner side of the cylindrical component 100. Two first waist-shaped holes are provided on a side wall of the inner wall radial slot seat 701, and the two first nut blocks 7043 are respectively located in the two first waist-shaped holes. A stroke control switch (not shown in the drawings) is further provided on a side surface of the inner wall radial slot seat 701, located on a side of one of the two first waist-shaped holes, for controlling a stroke of each of the two first nut blocks 7043.

As illustrated in FIG. 4, an ultrasonic vibration device 10 is disposed on the inner wall roller seat 702. The ultrasonic vibration device 10 includes two ultrasonic vibrators, which are respectively disposed on a first vertical side surface 7022 of the inner wall roller seat 702 facing away from the inner wall roller 703 and a second vertical side surface 7024 adjacent to the first vertical side surface 7022. Thus, independent ultrasonic vibrators are provided along radial and tangential directions of the cylindrical component 100 on the inner wall roller seat 702 to coordinately achieve a two-dimensional ultrasonic vibration corresponding to a required waveform. Under the two-dimensional ultrasonic vibration, it is easier to complete the radial loading of the two inner wall rollers 703 to bite into the inner wall of the cylindrical component 100 before rolling strengthening. Then, the cylindrical component 100 rotates uniformly, driving the two inner wall rollers 703 to rotate passively, achieving continuous biting and rolling strengthening.

The inner wall ultrasonic roller device 7 highly integrates functions such as the rollers, the ultrasonic vibration device, and bidirectional feeding, achieving overall simplification of the apparatus of the disclosure and providing more possibilities for application scope and process design. Especially for additively manufactured cylindrical components, the inner wall ultrasonic roller device 7 achieves gradient strengthening and toughening of a thick-walled integral structure, and greatly improves the quality and efficiency of strengthening and toughening with the aid of ultrasonic vibration.

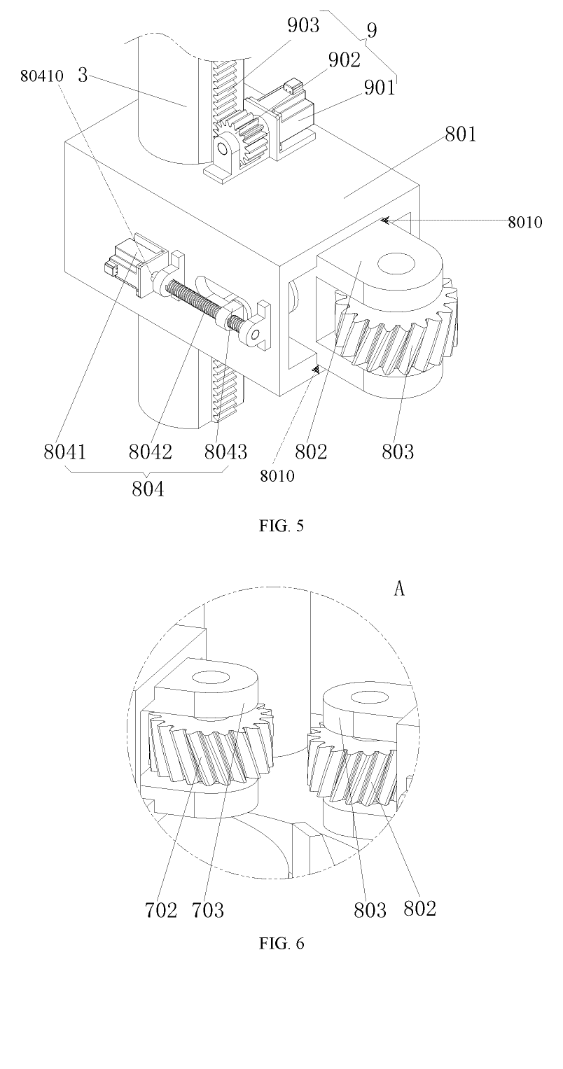

Two outer wall ultrasonic roller devices 8 are symmetrically arranged on two sides of the inner wall ultrasonic roller device 7. As illustrated in FIG. 5, each outer wall ultrasonic roller devices 8 includes an outer wall radial slot seat 801, an outer wall roller seat 802 slidably disposed within the outer wall radial slot seat 801, an outer wall roller 803 rotatably disposed at an end of the outer wall roller seat 802 and arranged opposite to a corresponding one of the two inner wall rollers 703, and a horizontal positioning mechanism 804 fixedly disposed on an outer wall of the outer wall radial slot seat 801. Specifically, similar to a structure of the inner wall ultrasonic roller device 7, two second radial guide grooves 8010 are respectively provided on inner surfaces of upper and lower walls of the outer wall radial slot seat 801. Upper and lower ends of each outer wall roller seat 802 are slidably embedded in the two second radial guide grooves 8010, allowing the outer wall roller seat 802 to move horizontally within the outer wall radial slot seat 801, and achieving radial position adjustment of the outer wall roller 803 on the outer wall roller seat 802 through extension or retraction. In this embodiment, axes of each inner wall roller 703 and each outer wall roller 803 are located in a same vertical plane, and the rotation axis of the rotating base 4 is located within the same vertical plane. Thus, after the inner wall roller 703 and the outer wall roller 803—both located on a same side of the cylindrical component 100—are paired and act together, the inner wall roller 703 and the outer wall roller 803 can clamp and counter-roll a wall on this same side of the cylindrical component 100. Moreover, two counter-rolling positions are located at opposite ends of a diameter of a horizontal cross-section of the cylindrical component 100, so that the two counter-rolling positions are symmetrically arranged on two sides of the cylindrical component 100, eliminating uneven force and deformation that one-sided rolling would cause.

As illustrated in FIG. 5, in this embodiment, the horizontal positioning mechanism 804 includes a second drive motor 8041 fixedly disposed on the outer wall radial slot seat 801, a screw 8042 rotatably disposed on the outer wall radial slot seat 801, and a second nut block 8043 threadedly connected to the screw 8042. An end of the second nut block 8043 penetrates the outer wall radial slot seat 801 and is fixedly connected to the outer wall roller seat 802. An output shaft end 80410 of the second drive motor 8041 is transmission-connected to an end of the screw 8042. Specifically, the second drive motor 8041 may also be a servo motor and is fixedly installed on the outer wall radial slot seat 801 through a motor mounting seat. Two ends of the screw 8042 are rotatably disposed on a side of the outer wall radial slot seat 801 via bearing seats. The output shaft end 80410 of the second drive motor 8041 is transmission-connected to the end of the screw 8042. By driving the screw 8042 to rotate through the second drive motor 8041, the second nut block 8043 and the outer wall roller seat 802 fixedly connected thereto are driven to move horizontally through the threaded transmission between the screw 8042 and the second nut block 8043, thereby realizing the radial feeding of the outer wall roller 803 on the outer side of the cylindrical component 100. A second waist-shaped hole is provided on a side wall of the outer wall radial slot seat 801, and the second nut block 8043 is located in the second waist-shaped hole. A stroke control switch (not shown in the drawings) is also provided on a side surface of the outer wall radial slot seat 801, located on a side of the second waist-shaped hole, for controlling a stroke of the second nut block 8043.

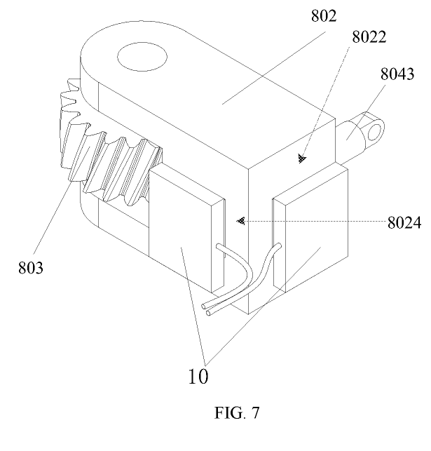

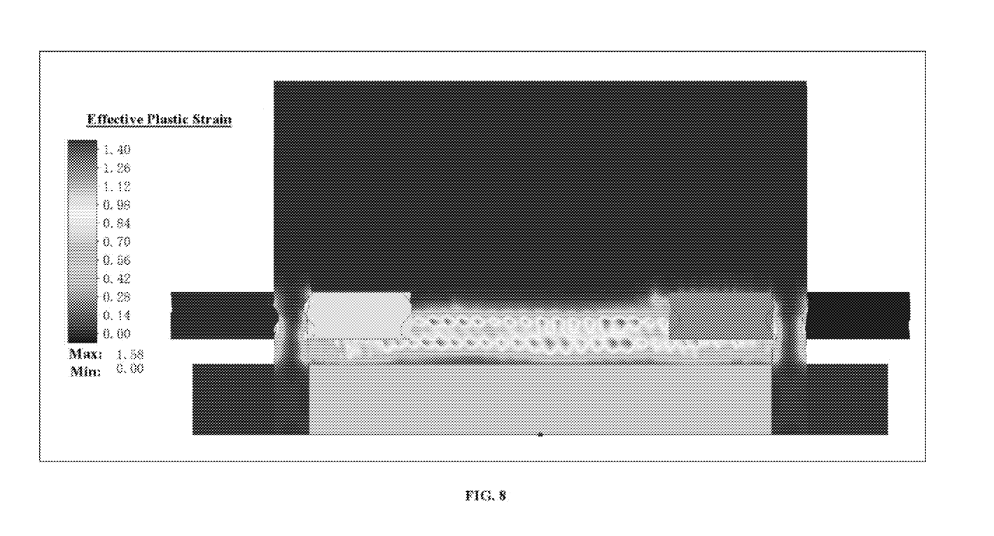

Similar to the inner wall radial slot seat 701, an ultrasonic vibration device 10 is also disposed on the outer wall radial slot seat 801. As shown in FIG. 7, the ultrasonic vibration device 10 also includes two ultrasonic vibrators, which are respectively disposed on a third vertical side surface 8022 of the outer wall roller seat 802 facing away from the outer wall roller 803 and a fourth vertical side surface 8024 adjacent to the third vertical side surface 8022. Each inner wall roller 703 and each outer wall roller 803 are helical cylindrical gears with opposite helical directions or are both cylindrical rollers. Thus, when a pair of an inner wall roller 703 and an outer wall roller 803 (i.e., a roller pair) adopts helical cylindrical gears, which are symmetrically arranged, after the roller pair clamps a side wall of the cylindrical component 100 and performs paired rolling, cross-shaped tooth marks can be formed on inner and outer surfaces of the side wall of the cylindrical component 100, making the rolling efficiency higher, while alleviating the common problems of thinning and elongation during the rolling process.

To facilitate component manufacturing and improve versatility between components, in this embodiment, the inner wall radial slot seat 701 of the inner wall ultrasonic roller device 7 is formed by splicing two outer wall radial slot seats 801 opposite to each other. A structure of the inner wall roller seat 702 is the same as that of the outer wall roller seat 802. When the inner wall roller 703 and the outer wall roller 803 in each roller pair are cylindrical rollers, structures of the inner wall roller 703 and the outer wall roller 803 in each roller pair are also the same.

Each of the two outer wall ultrasonic roller devices 8 is transmission-connected to a corresponding one of the four guide columns 3 through a second vertical positioning mechanism 9. The second vertical positioning mechanism 9 realizes feeding and positioning of the outer wall ultrasonic roller device 8 in the axial direction of the cylindrical component 100. As illustrated in FIG. 5, the second vertical positioning mechanism 9 includes a rack 903 vertically disposed and fixed on a side wall of the guide column 3 facing toward the rotating base 4, a third drive motor 901 fixedly installed on a top surface of the outer wall radial slot seat 801 through a motor mounting seat, and a lifting gear 902 fixedly installed on an output shaft end of the third drive motor 901 and meshing with the rack 903 for transmission. The third drive motor 901 is also a servo motor. By driving by the third drive motor 901 the lifting gear 902 to rotate, an overall lifting and positioning of the outer wall ultrasonic roller device 8 are achieved through gear-rack transmission between the lifting gear 902 and the rack 903. For this purpose, a through hole matching an outer diameter of a corresponding one guide column 3 is provided at a tail of each outer wall radial slot seat 801. The corresponding one guide column 3 is located in the through hole, realizing a vertical guidance of the outer wall ultrasonic roller device 8 on the guide column 3. A chord plane is provided on a side wall of the corresponding one guide column 3 facing toward the rotating base 4, creating a space between the corresponding one guide column 3 and an inner wall of the through hole, so that the rack 903 is located within this space and does not interfere with the inner wall of the through hole.

The cylindrical component 100 produced by additive manufacturing or machining may contain a significant residual stress. A stress-relief anneal is therefore required to lower the significant residual stress and improve the stability of a subsequent roll pressing process. Meanwhile, based on material characteristics, solution treatment and aging treatment can be implemented to optimize a matrix structure to achieve a uniform and stable performance foundation, thereby providing ideal conditions for roller strengthening. Prior to the roller strengthening, a surface of the cylindrical component 100 must be thoroughly cleaned to remove oil, oxide scale, and contaminants, ensuring full contact between the rollers and the surface of the cylindrical component 100. This can be accomplished through ultrasonic cleaning, chemical cleaning, or sandblasting. Additionally, a protective lubricant or solid lubricating film should be applied to the surface of the surface of the cylindrical component 100 before the roller strengthening to reduce the friction coefficient during the roller strengthening, minimize surface damage, and improve processing quality.

The disclosure further provides a method for surface toothed-roll strengthening and toughening of an additively manufactured cylindrical component, which includes the following steps S1 through S8.

In the step S1, a cylindrical component 100 is fixed on a rotating base 4 through a positioning assembly 5.

Before performing the step S1, it is necessary to ensure that each of an inner wall ultrasonic roller device 7 and two outer wall ultrasonic roller devices 8 is at a highest vertical position to facilitate the installation operation of the cylindrical component 100. Meanwhile, an inner wall roller seat 702 should be retracted to an innermost end of an inner wall radial slot seat 701, and an outer wall roller seat 802 of each of the two outer wall ultrasonic roller devices 8 is retracted to an innermost end of an outer wall radial slot seat 801 of the outer wall ultrasonic roller device 8, so that a radial distance between an inner wall roller 703 and an outer wall roller 803 at a same side of the cylindrical component 100 is sufficiently large, which allows each of the two roller pairs (each roller pair consists of one inner wall roller 703 and one outer wall roller 803 at a same side of the cylindrical component 100) to smoothly enter a bottom side wall of the cylindrical component 100 after the cylindrical component 100 is installed and fixed on the rotating base 4.

After ensuring each of the two roller pairs is at a safe height, the cylindrical component 100 is installed between a positioning inner core 501 and a positioning pressure ring 502. Good cooperation between the cylindrical component 100 and the positioning inner core 501 ensures that the cylindrical component 100 is at an exact center of the rotating base 4 and an axial perpendicularity of the cylindrical component 100 is within a desired error range, thereby avoiding problems such as large-area uneven stress distribution and instability caused by tilting of the cylindrical component 100. Then, positioning wedge blocks 503 cooperate with the positioning inner core 501 to press against a side wall of the cylindrical component 100, and clamping pressures at points where the positioning wedge blocks 503 press against side wall of the cylindrical component 100 are kept consistent to prevent sliding of the cylindrical component 100 during a rotational processing of the cylindrical component 100 due to uneven friction.

In the step S2, the inner wall rollers 703 and the outer wall rollers 803 are designed as helical cylindrical gears, the inner wall rollers 703 and the outer wall rollers 803 are initially positioned at lowest positions, and initial positions of the inner wall rollers 703 and the outer wall rollers 803 are adjusted so that radial distances between each of the inner wall rollers 703 and the outer wall rollers 803 and a wall of the cylindrical component 100 are identical.

Due to the inevitable minor dimensional deviations in the additively manufactured cylindrical components 100, it is necessary to position the inner wall rollers 703 and the outer wall rollers 803 before starting a rolling strengthening process. After each roller synchronously feeds axially to a bottom of the cylindrical component 100, radial distances between each roller and a corresponding inner or outer wall of the cylindrical component 100 are adjusted uniformly and are maintained at 15 mm, thereby ensuring identical feed distances between the rollers and the wall of the cylindrical component 100.

In the step S3, a rotation speed of the cylindrical component 100, a radial feed parameter of each of the inner wall rollers 703 and the outer wall rollers 803, and an axial feed parameter of each of the inner wall rollers 703 and the outer wall rollers 803, and ultrasonic vibration parameters are set.

When the cylindrical component 100 is a 2-series aluminum alloy, a vibration frequency of each of the ultrasonic vibration devices is set to 10 kHz to 20 kHz, an amplitude of each of the ultrasonic vibration devices is set to 15 μm, and a power of each of the ultrasonic vibration devices is set to 1000 W. Before each roller performs feeding, each ultrasonic vibration device 10 is turned on to realize two-dimensional vibration. A radial feed speed of each roller is set to 1 mm/s, and the rotation speed of the cylindrical component 100 is set to 0.628 rad/s, which means that the cylindrical component 100 completes one revolution in 10 seconds (s), corresponding to a rotation angle of 2π. Within a rotation cycle (i.e., 10 s) of the cylindrical component 100, an axial feed distance of each roller is equal to or less than an axial thickness of the roller to ensure that the rolled tooth marks completely cover the wall of the cylindrical component 100.

In the step S4, the ultrasonic vibration devices 10 are started, the two inner wall rollers 703 and the two outer wall rollers 803 synchronously feed a preset distance towards the wall of the cylindrical component 100 radially at a preset feed speed, to make the two inner wall rollers 703 bite into an inner wall of the cylindrical component 100 and make the two outer wall rollers 803 bite into an outer wall of the cylindrical component 100.

After each ultrasonic vibration device 10 is started, a horizontal bidirectional positioning mechanism 704 drives the two inner wall rollers 703 to gradually approach the inner wall of the cylindrical component 100 synchronously. Simultaneously, the two horizontal positioning mechanisms 804 at two sides of cylindrical component 100 drive the two outer wall rollers 803 to gradually approach the outer wall of the cylindrical component 100, respectively, until that the two inner wall rollers 703 and the two outer wall rollers 803 synchronously feed the preset distance towards the wall of the cylindrical component 100 radially. Then, both the horizontal bidirectional positioning mechanism 704 and the two horizontal positioning mechanisms 804 stop working. For gradient structure strengthening of a rocket section, an outer circular side wall of each helical cylindrical gear is fed to 15% of a wall thickness of rocket section.

In the step S5, the rotating base 4 drives the cylindrical component 100 to rotate uniformly at a preset rotation speed for a preset time to make the cylindrical component 100 complete one revolution; then, each roller synchronously feeds axially upward at a uniform speed by a preset single roller axial width. During a uniform rotation of the cylindrical component 100, the inner wall roller 703 and the outer wall roller 803 on a same side of the cylindrical component 100 rotate passively, thereby cooperatively rolling the inner and outer surfaces of the cylindrical component 100, achieving continuous biting and rolling strengthening. Double spiral cross trajectories on both sides of the cylindrical component 100 can form cross-shaped tooth marks on the inner and outer surfaces of a side wall of the cylindrical component 100, making the rolling efficiency higher and simultaneously alleviating the common problems of thinning and elongation during the rolling process.

After the cylindrical component 100 has completed one full rotation, a bottom circle of the side wall of the cylindrical component 100 is completely covered by the rolling process. At this time, the first vertical positioning mechanism 6 drives the inner wall ultrasonic roller device 7 to start rising axially at a preset constant speed. The two second vertical positioning mechanisms 9 respectively drive the two outer wall ultrasonic roller devices 8 to rise axially synchronously with the inner wall ultrasonic roller device 7. For each rotation of the cylindrical component 100, the two outer wall ultrasonic roller devices 8 move axially by a preset axial distance, ensuring the tooth marks completely cover the wall of cylindrical component 100. Under the combined action of the rotation of the cylindrical component 100 and a axial linear movement of the two roller pairs, double spiral trajectory strengthening of the wall of the cylindrical component 100 is achieved. Until top ends of all rollers exceed a topmost end of the cylindrical component 100, a last rolling is completed. The horizontal bidirectional positioning mechanism 704 drives the two inner wall rollers 703 to gradually move away from the inner wall of the cylindrical component 100 synchronously. Simultaneously, the two horizontal positioning mechanisms 804 respectively drive the two outer wall rollers 803 to gradually move away from the outer wall of the cylindrical component 100, respectively, completing a radial reset of each roller. Then, the apparatus pauses.

In the step S6, each roller is replaced with a cylindrical roller of a diameter the same as that of the roller and each cylindrical roller is positioned to the lowest position. The steps S4 to S5 are repeated to complete a roller leveling process of the wall of the cylindrical component 100. Due to the innovative cross pressing marks, during roller leveling process, a radial feed distance of each roller towards the wall thickness of the cylindrical component 100 is changed to 8% of the wall thickness of the cylindrical component 100. The radial feed distance of each cylindrical roller is less than that of the helical cylindrical gear in a same pass.

In the step S7, the radial feed distance of each roller biting into the wall of the cylindrical component 100 is gradually reduced by a preset reduction amount. The steps S3 to S6 are repeated for a preset number of times to complete a gradient structure strengthening and toughening of the wall of the cylindrical component 100. In this embodiment, the radial feed distance of a next pass is 80% of that of a previous pass, i.e., a radial feed distance reduction per pass is 20%.

In the step S8, the cylindrical component 100 is remove from the rotating base 4, and heat treatment optimization and surface repair are performed on the cylindrical component 100.

Specifically, each positioning wedge block 503 is moved radially outward to release the clamping of the cylindrical component 100. At this time, all rollers that have completed rolling strengthening are at a highest position, and the cylindrical component 100 can be taken off from the rotating base 4. Then, a surface of the cylindrical component 100 is thoroughly cleaned by methods such as ultrasonic cleaning, chemical cleaning, or high-pressure water rinsing to ensure the effect of subsequent treatments. After appropriate heat treatment optimization and surface repair, an excess waste material at pressing and positioning positions corresponding to the positioning wedge blocks 503 is removed by machining.

In the disclosure, a single-pass simulation of the method for surface toothed-roll strengthening and toughening of the additively manufactured cylindrical component is performed using a process simulation function of Simufact Forming software.

(1) Pre-processing for toothed rolling: A driver program for the apparatus uses a tabular driving motor to control its movement speed and trajectory. The general idea is that the roller feeds radially first, then a blank starts to rotate, and then the roller feeds axially. Meanwhile, a spiral strengthening trajectory and a depth are designed through parameters such as a rotation speed of a lower bottom die (corresponding to the aforementioned rotating base 4), and speed, direction, and time parameters of each roller feed.

The pre-processing for toothed rolling mainly includes the following four parts.

In a first part, movement of the lower bottom die and the blank is performed. Specifically, a uniform rotation of the lower bottom die is controlled through a motor to drive the cylindrical blank to rotate at 0.628 rad/s, i.e., one revolution in 10 seconds. Simultaneously, the lower bottom die and the blank adopt viscous contact to ensure that no excessive relative sliding occurs between the lower bottom die and the blank (the friction coefficient adopts shear-type friction with a factor of 0.4.

In a second part, a radial motion of each helical gear roller (corresponding to the inner wall rollers 703 and the outer wall rollers 803 designed as the helical cylindrical gears) is performed. Specifically, when two pairs of helical gear rollers feed radially towards a wall thickness direction of the blank, two helical gear rollers will move synchronously in an X direction, and the other two helical gear rollers will move synchronously in a -X direction. Therefore, in this simulation, two hydraulic machines with mirrored motion parameters are used for representing the four helical gear rollers. The model scales down a wall thickness of the blank to 15 mm proportionally. By controlling an X-direction speed and a motion time, each helical gear roller is made to feed 2 mm radially towards the wall thickness direction of the blank.

In a third part, an axial motion of each helical gear roller is performed. Specifically, a rotation speed of the blank and an axial motion of each helical gear roller determine a double helix trajectory. Combining a thickness of each roller itself and a height of the wall of the blank, through multiple attempts, an axial motion speed of each helical gear roller is set to 2 mm/s. The double helix trajectory under this axial motion speed can completely cover an entire cylinder wall surface of the blank and avoids repeated coverage of the previous layer by the next spiral layer, making the overall strengthening effect more uniform.

In a fourth part, temperature and motion constraint parameters are determined. Specifically, a temperature for forming is room temperature, and during deformation, the temperature rises naturally. Each roller is set to perform passive rotation. A rotation axis of each roller remains unchanged, and parameters such as rotation directions, frictions, motion constraints, torque springs are set. The bottom die is set to perform active rotation, and the bottom die is bonded to the blank to make the bottom die be in contact with the blank to drive rotation of the blank.

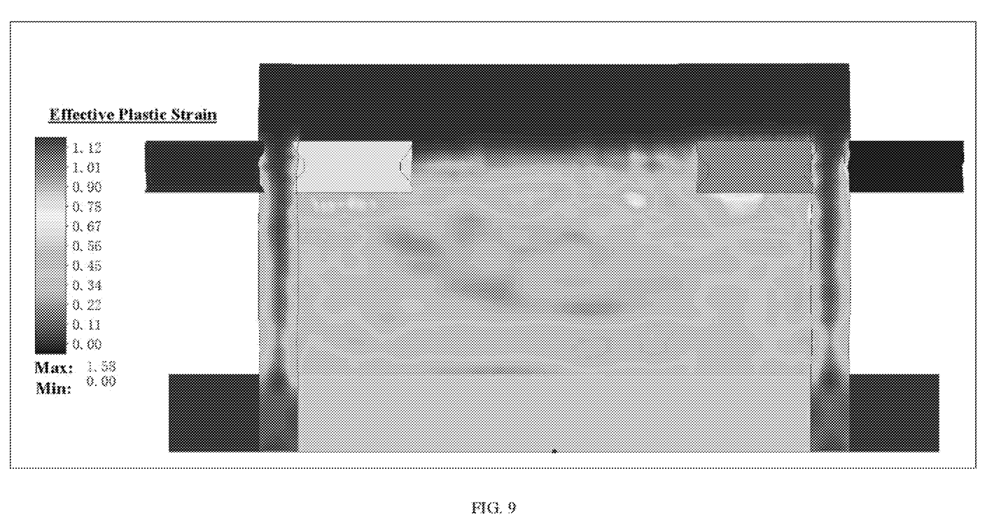

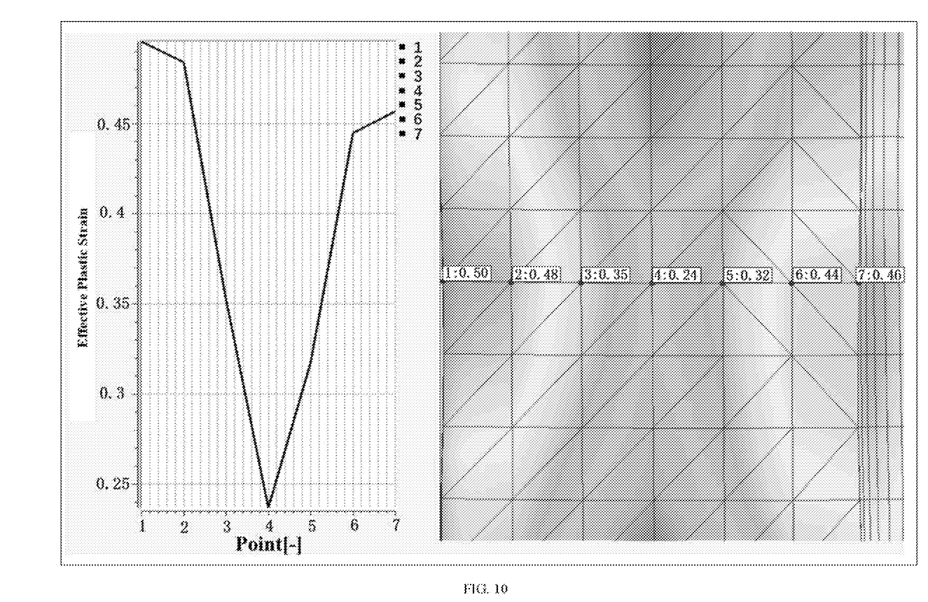

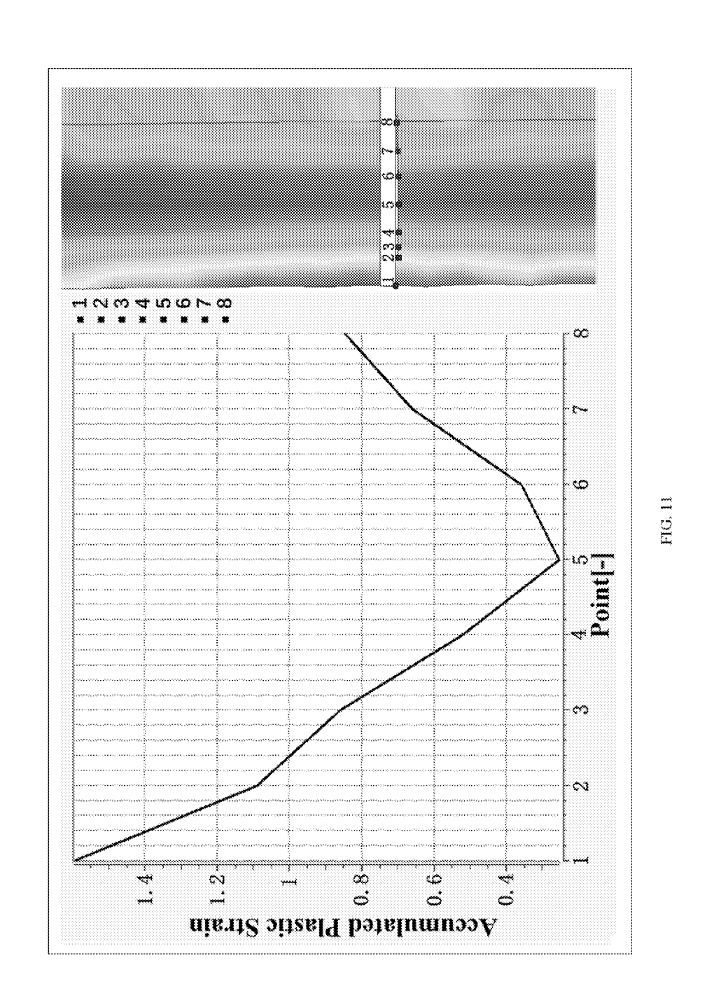

(2) Post-processing results for toothed rolling: From the analysis of FIGS. 8 and 9, it can be seen that reinforced tooth marks on the cylinder wall are improved, and a strain distribution of each tooth mark and a strain distribution between tooth marks is uniform. A plastic strain gradient effect of the whole wall thickness is obvious, and there is no obvious deformation instability. After the first pass of roll-forming, the gradient accumulated plastic strain meets the requirements. Moreover, the cylinder wall shows no significant thinning or elongation, which facilitates subsequent machining and improves material utilization. As shown in FIG. 10, a radial effective plastic strain curve of the whole cylinder wall is obtained by taking seven effective plastic strain reference points uniformly along the radial direction. It can be seen from the curve that the strains at both ends of the curve are obvious, which gradually decreases in a gradient toward the middle section, fully illustrating the gradient strengthening effect of this process.

(3) Pre-processing for roller leveling: A radial feed distance of each roller leveling roller (corresponding to the inner wall rollers 703 and the outer wall rollers 803 designed as cylindrical rollers) towards the wall thickness is changed to 1 mm, and other parameters are kept consistent with those in the aforementioned toothed rolling process.

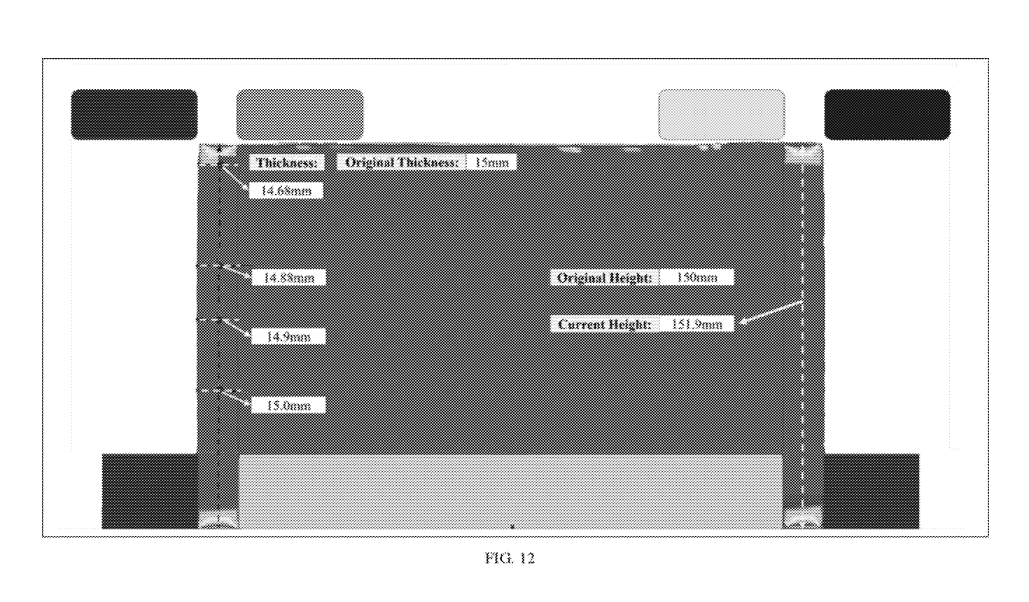

(4) Post-processing results for roller leveling: FIG. 11 shows a radial accumulated plastic strain distribution after roller leveling. Eight points are selected radially on the cylinder wall to obtain an accumulated plastic strain curve. It can be clearly seen that the accumulated plastic strain distribution shows a trend of low in the middle and gradually increasing at both ends, fully demonstrating the gradient structure strengthening effect of this process, and the strengthening and toughening effect is better on the outer wall part where service conditions are more severe. FIG. 12 shows a thickness change diagram of the cylinder wall. It can be seen that with this process, only a very small part at a top end of the blank has excessive thinning. After measuring a height of the cylindrical component and thicknesses at multiple locations of the cylindrical component, it is found that except for a top part, a maximum thinning rate in three scattered measured locations is 0.8%, and an overall height increases by 1.2%, which is within the reasonable range of machining allowance.

The technical features of the above-described embodiments can be arbitrarily combined. For the sake of concise description, not all possible combinations of the technical features in the above embodiments are described. However, as long as there is no contradiction in the combination of these technical features, they should be considered as within the scope recorded in this specification.

The above descriptions are only embodiments of the disclosure and are not intended to limit the scope of protection of the disclosure. Any equivalent structure or equivalent process transformation made using the contents of the specification and drawings of the disclosure, or directly or indirectly applied in other related technical fields, shall be similarly included in the scope of protection of the disclosure.

What is claimed is:

1. An apparatus for surface toothed-roll strengthening and toughening of an additively manufactured cylindrical component, comprising a lower die seat, an upper die seat disposed above the lower die seat, and guide columns fixedly disposed between the lower die seat and the upper die seat;
wherein a rotating base is disposed inside the lower die seat, a positioning assembly is disposed on the rotating base, a first vertical positioning mechanism is disposed on a bottom surface of the upper die seat, and a bottom positioning end of the first vertical positioning mechanism is fixedly connected to an inner wall ultrasonic roller device; and the inner wall ultrasonic roller device comprises: an inner wall radial slot seat, two inner wall roller seats symmetrically and slidably disposed in two ends of the inner wall radial slot seat, and two inner wall rollers rotatably disposed at two outer ends of the two inner wall roller seats, wherein axes of the two inner wall rollers are vertically arranged;
wherein two outer wall ultrasonic roller devices are symmetrically arranged on two sides of the inner wall ultrasonic roller device; each of the two outer wall ultrasonic roller devices comprises: an outer wall radial slot seat, an outer wall roller seat slidably disposed within the outer wall radial slot seat, and an outer wall roller, which is rotatably arranged at an end of the outer wall roller seat and arranged opposite to a corresponding one of the two inner wall rollers; each of the two outer wall ultrasonic roller devices is transmission-connected to a corresponding one of the guide columns through a second vertical positioning mechanism, and the two inner wall rollers and the two outer wall rollers of the two outer wall ultrasonic roller devices are helical cylindrical gears with opposite helical directions; and
wherein each of the inner wall radial slot seat and the two outer wall radial slot seats of the two outer wall ultrasonic roller devices is provided with an ultrasonic vibration device thereon.

2. The apparatus for surface toothed-roll strengthening and toughening of the additively manufactured cylindrical component as claimed in claim 1, wherein the inner wall ultrasonic roller device further comprises a horizontal bidirectional positioning mechanism, the horizontal bidirectional positioning mechanism is fixedly disposed on an outer wall of the inner wall radial slot seat, the two inner wall roller seats are fixedly connected to two positioning output ends of the horizontal bidirectional positioning mechanism, respectively, and the two inner wall roller seats are configured to move synchronously towards or away from each other.

3. The apparatus for surface toothed-roll strengthening and toughening of the additively manufactured cylindrical component as claimed in claim 2, wherein the horizontal bidirectional positioning mechanism comprises: a first drive motor, fixedly disposed on the inner wall radial slot seat, a bidirectional screw, horizontally and rotatably disposed on the inner wall radial slot seat, and two first nut blocks, threadedly connected to two ends of the bidirectional screw, respectively; an
end of each of the two first nut blocks penetrates the inner wall radial slot seat and is fixedly connected to a corresponding one of the two inner wall roller seats, respectively; and an output shaft end of the first drive motor is transmission-connected to a middle part of the bidirectional screw through a gear pair.

4. The apparatus for surface toothed-roll strengthening and toughening of the additively manufactured cylindrical component as claimed in claim 3, wherein two first radial guide grooves are respectively provided on inner surfaces of upper and lower walls of the inner wall radial slot seat, and upper and lower ends of each of the two inner wall roller seats are slidably embedded in the two first radial guide grooves, respectively.

5. The apparatus for surface toothed-roll strengthening and toughening of the additively manufactured cylindrical component as claimed in claim 1, wherein each of the two outer wall ultrasonic roller devices further comprises a horizontal positioning mechanism;
the horizontal positioning mechanism is fixedly disposed on an outer wall of the outer wall radial slot seat of the outer wall ultrasonic roller device;
the horizontal positioning mechanism comprises: a second drive motor, fixedly disposed on the outer wall radial slot seat of outer wall ultrasonic roller device, a screw, rotatably disposed on the outer wall radial slot seat, and a second nut block, threadedly connected to the screw; an end of the second nut block penetrates the outer wall radial slot seat of the outer wall ultrasonic roller device and is fixedly connected to the outer wall roller seat of the outer wall ultrasonic roller device; and an output shaft end of the second drive motor is transmission-connected to an end of the screw.

6. The apparatus for surface toothed-roll strengthening and toughening of the additively manufactured cylindrical component as claimed in claim 5, wherein two second radial guide grooves are respectively provided on inner surfaces of upper and lower walls of the outer wall radial slot seat, and upper and lower ends of each of the two outer wall roller seats are slidably embedded in the two second radial guide grooves.

7. The apparatus for surface toothed-roll strengthening and toughening of the additively manufactured cylindrical component as claimed in claim 1, wherein the ultrasonic vibration device disposed on the inner wall ultrasonic roller device comprises two ultrasonic vibrators, which are respectively disposed on a first vertical side surface of the inner wall roller seat facing away from the inner wall roller and a second vertical side surface adjacent to the first vertical side surface; and
wherein the ultrasonic vibration device disposed on each of the two outer wall ultrasonic roller devices comprises two ultrasonic vibrators, which are respectively disposed on a third vertical side surface of the outer wall roller seat of the outer wall ultrasonic roller device facing away from the outer wall roller and a fourth vertical side surface adjacent to the third vertical side surface.

8. The apparatus for surface toothed-roll strengthening and toughening of the additively manufactured cylindrical component as claimed in as claimed in claim 1, wherein axes of the two inner wall rollers and axes of the two outer wall rollers are located in a same vertical plane, and a rotation axis of the rotating base is located within the same vertical plane.

9. A method for surface toothed-roll strengthening and toughening of an additively manufactured cylindrical component, applied to the apparatus for surface toothed-roll strengthening and toughening of the additively manufactured cylindrical component as claimed in claim 1, and the method comprising the following steps:
S1, fixing the cylindrical component on the rotating base;
S2: designing the two inner wall rollers and the two outer wall rollers as the helical cylindrical gears, and initially positioning the two inner wall rollers and the two outer wall rollers at lowest positions;
S3, setting a rotation speed of the cylindrical component, a radial feed parameter of each of the two inner wall rollers and the two outer wall rollers, an axial feed parameter of each of the two inner wall rollers and the two outer wall rollers and ultrasonic vibration parameters;
S4, starting each the ultrasonic vibration device, and synchronously feeding the two inner wall rollers and the two outer wall rollers radially towards a wall of the cylindrical component until the two inner wall rollers and the two outer wall rollers bite into the wall of the cylindrical component;
S5, driving, by the rotating base, the cylindrical component to rotate at a preset constant speed; once the cylindrical component rotates one revolution, synchronously feeding the two inner wall rollers and the two outer wall rollers upward by a single roller axial width until each of the two inner wall rollers and the two outer wall rollers completely rolls over an uppermost end of the cylindrical component, then pausing the apparatus;
S6, replacing the helical cylindrical gears with cylindrical rollers, each of the cylindrical rollers has a diameter the same as each of the helical cylindrical gears, positioning the cylindrical rollers to the lowest positions, and repeating the steps S4 to S5 to complete a roller leveling process of the wall of the cylindrical component;
S7, gradually reducing a radial feed distance of each of the cylindrical rollers biting into the wall of the cylindrical component by a preset reduction amount, and repeating the steps S3 to S6 for a preset number of times to complete a gradient structure strengthening and toughening of the wall of the cylindrical component; and
S8, removing the cylindrical component, and performing heat treatment optimization and surface repair on the cylindrical component.

10. The method for surface toothed-roll strengthening and toughening of the additively manufactured cylindrical component as claimed in claim 9, wherein the radial feed distance of each of the cylindrical rollers is less than that of each of the helical cylindrical gears in a same pass.
